(19) United States
(12) Patent Application Publication
(10) Pub. No.: US 2006/0048198 A1
(43) Pub. Date: Mar. 2, 2006

(54) Establishing remote connections

(75) Inventors: Roland Hochmuth, Fort Collins, CO (US); Bruce Blaho, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/924,714

(22) Filed: Aug. 24, 2004

(51) Int. Cl. H04N 5/445; H04N 7/173; G06F 13/00

(52) U.S. Cl. 725/105; 725/45

(57) ABSTRACT

A remote network resource is contacted to acquire connection data. The connection data is associated with connecting a viewer to one or more senders. In response to the connection data, one or more connections are established between the viewer and the one or more senders. Graphical data is received over the connections from the one or more senders and presented to the viewer.

### BACKGROUND

Typically, if a viewing resource wants to remotely connect to a sending resource over a network connection then the initial configuration and connection are manually established by a user interfaced to the viewing resource. This is not an ideal solution because the sending resource may change its network address, such as when it is upgraded, moved, or replaced on the network. The sending resource may also change the mechanism by which connections are made or permitted, such as when modifications are made to network protocols, when modifications are made to security requirements that permit connections, and the like. As a result, when changes occur every resource that remotely connects to the sending resource has to be manually visited and manually reconfigured to ensure proper connectivity to the sending resource. Additionally, resources assigned to a particular user may be dynamically added or removed. Consequently, a user is often forced to manually maintain and configure his/her assigned resources.

Another problem with traditional remote connections is related to security. Generally, all a user has to have is an electronic identification and a password to a sending resource in order to establish a manual remote connection with that resource. The problem with this is that the user may have permission to access a certain service of a sending resource but not have permission to directly and remotely connect to the sending resource.

### BRIEF DESCRIPTION OF THE DRAWINGS

FIG. 1 is a diagram of method for establishing remote connections, according to an example embodiment.

FIG. 2 is a diagram of a method for facilitating the establishment of remote connections, according to an example embodiment.

FIG. 3 is a diagram of another method for establishing a remote connection, according to an example embodiment.

FIG. 4 is a diagram of a remote connection system, according to an example embodiment.

FIG. 5 is a diagram of another remote connection system, according to an example embodiment.

### DETAILED DESCRIPTION

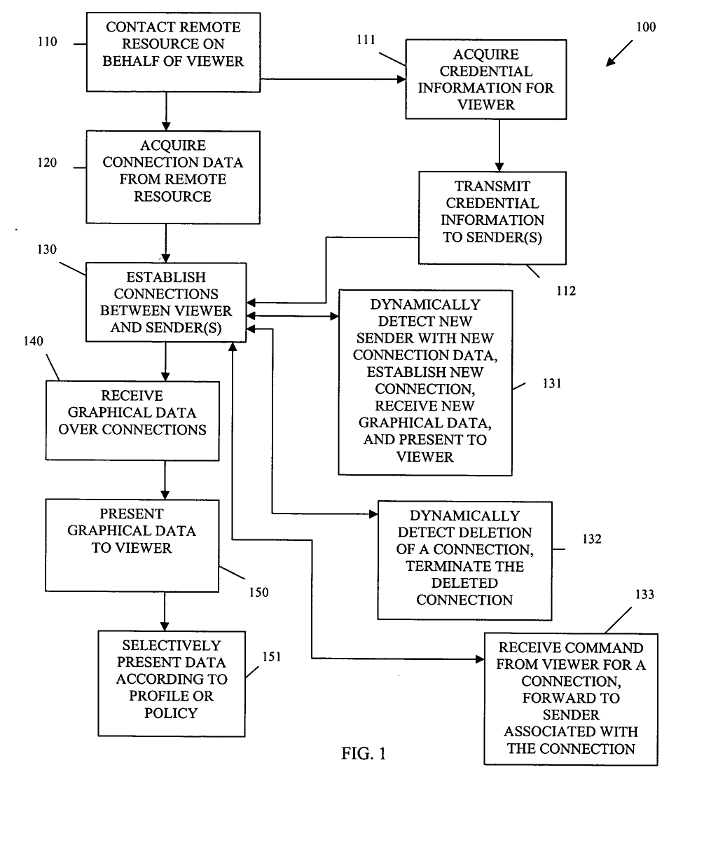

FIG. 1 is a diagram of one method 100 to establish remote connections, according to an example embodiment. The method 100 (hereinafter “receiver service”) is implemented in a machine-accessible and readable medium and is operational over a network. The network may be hardwired, wireless, or a combination of hardwired and wireless.

The receiver service processes on a processing device that is in communication with and interfaced to a viewer. A viewer may be a processing device, a service or application executing on a processing device, and/or a user that is identified via a user identification and security information that is interacting with services or applications executing on a processing device. The viewer may also be associated with one or more display monitors or devices for viewing information over the network which processes on a sender. Receivers and viewers are physical and/or logical resources. Thus, in some cases viewers can be users who are identified as logical resources via identifications. In this manner, a viewer can be mobile (not tied to any particular architecture, configuration, or physical location) and can associate with physical resources (e.g., processing devices, displays, networks, etc.) once the viewer logically identifies itself via a login process.

A sender is a processing device or a service or application processing on a processing device. The sender is remote from the viewer. That is, the sender and viewer are geographically dispersed from one another over the network. Moreover, the sender and the receiver service are geographically dispersed from one another. The viewer and the receiver service may be locally networked to one another but are geographically in proximity to one another.

The receiver service interacts with a remote resource and one or more senders on behalf of a viewer for purposes of automatically establishing connection between the viewer and the one or more senders. The processing of the receiver service may be initiated in a variety of manners. For example, when a viewer logs into the network a profile associated with the viewer may indicate that the receiver service is to be initiated as part of the login process. Alternatively, the viewer may manually initiate the receiver service via other instructions or interfaces when the viewer desires to do so.

Once initiated, the receiver service identifies the viewer to which it is servicing. This may entail acquiring the identity of the viewer and/or acquiring other credential information associated with the viewer, such as certificates, keys, signatures, passwords, etc. Next, at 110, the receiver service contacts a remote resource for purposes of acquiring identities of senders and connection data associated with the senders which permit the receiver service to configure and connect the viewer to one or more of the senders.

The identity and location of the remote resource may be associated with a profile of the viewer, which is accessible to and acquired by the receiver service. Alternatively, the identity and location of the remote resource may be acquired from a third-party service on request made by the receiver service, where the receiver service provides an identity for the viewer to the third-party service. In still other embodiments, the identity and location of the remote resource may be configured with configuration information associated with the receiver service or may be provided as a command line parameter to the receiver service.

The remote resource may have its own interface, such as a directory, a database, or a data warehouse interface that may be used by the receiver service to contact and query the remote resource. Alternatively, the remote resource may not have an interface and is thus parsed by instructions of the receiver service in order to acquire connection data. That is, the remote resource may be a directory, a database, a data warehouse, a website, or an electronic file. In one embodiment, the remote resource is a directory and the receiver service uses a Lightweight Directory Access Protocol (LDAP) interface to interact with the remote resource.

Once the receiver service knows the identity or location of the remote resource and knows what interface or lack of interface is needed to interact with the remote resource, the receiver service, at 120, acquires connection data from the remote resource. The connection data identifies senders that the viewer may be permissibly connected to. In some embodiments, the connection data identifies an Internet Protocol (IP) address for each of the senders or hostnames for each of the senders. Optionally, the connection data may include other metadata information about connections to each of the senders, such as protocol used, connection rate, security information, and any policies that are enforced with a particular connection. A policy are statements that can be evaluated, such as conditions or events that dictate when, how, and if a connection may proceed or if it is to be terminated. For example, a policy may state that a particular connection to a particular sender may only occur at a certain time of day, calendar day, or upon the occurrence of some detectable event. Policies are configurable and optional.

In one embodiment, at 111, where policies and/or security information are deployed for connections to senders, the receiver service acquires credentials for the viewer that it is servicing. The credential information may be a digital signature, public certificate, or other key associated with the identity of the viewer. At 112, the receiver service transmits the credential information to the senders that require as a precondition to a connection credential verification or authentication of a connecting sender.

At 130, the receiver service uses the connection data to establish connections between the viewer and one or more of the senders. That is, an active communication session between the viewer and each of the senders is established. This means that both the viewer and each sender participating in a particular connection are using the same protocols and are in active communication with one another over the network. The viewer may have multiple active connections to separate senders. Alternatively, the viewer may have a single active session to a single sender.

Additionally, in some embodiments, a single receiver service (embodied as method 100 of FIG. 1) may service a plurality of different and distinct viewers. Thus, two separate viewers may be locally networked or interfaced to the same receiver service.

In some embodiments, at 131, during any particular active connection to a sender, the receiver service may detect that a new sender has been dynamically added to the remote resource. In these embodiments, the receiver service may be configured to automatically contact the remote resource and acquire the new connection data associated with the new service. Next, the receiver service establishes a new connection to the new service in response to the newly acquired connection data associated with the new service. During that new connection, the new sender may send graphical data related to its display or services, that new graphical data is received by the receiver service and presented to the viewer. The presentation may be automatic, which means that the viewer may not even be aware of what is and has transpired between the receiving service, the new sender, and the remote resource until the new connection and new graphical data appear on a display of the viewer. Alternatively, the receiver service may notify the viewer that a new connection has been established with a new sender and that graphical data is available upon manual selection and activation of the viewer.

In another embodiment, at 132, the receiver service may detect that a particular connection is no longer authorized pursuant to communications received or propagated from the remote resource. That is, an administrator may be monitoring connections or may determine that a viewer is no longer authorized to be connected to a particular sender. The administrator may modify the remote resource to reflect this change and the remote resource or other interfaces associated with the remote resource may notify the receiver service. Under these circumstances, the receiver service may terminate the affected connection, which terminates that connection with the viewer.

The receiver service may also facilitate two-way communications between services executing on the senders and actions taken by the viewer. Thus, at 133, the receiver service may detect a command issued or selected by the viewer on a particular connection and send that command over the network to the sender associated with the connection.

At 140, during active connections between the viewer and the one or more senders, graphical data associated with processing of services and/or display information of a sender is received over the connections by the receiver service. At 150, the receiver service presents the graphical data to the viewer. This may entail presenting the data within a single subset of windows on a single display of the viewer, or presenting the data on a plurality of different displays associated with the viewer.

In some embodiments, at 151, the arrangement and placement of the presented graphical data may be selectively presented and driven by profiles and/or policies associated with the viewer. These profiles or policies may reside locally within the environment of the viewer, within the environment of the receiver service, or may be acquired from the receiver service from the remote resource that provides the connection data.

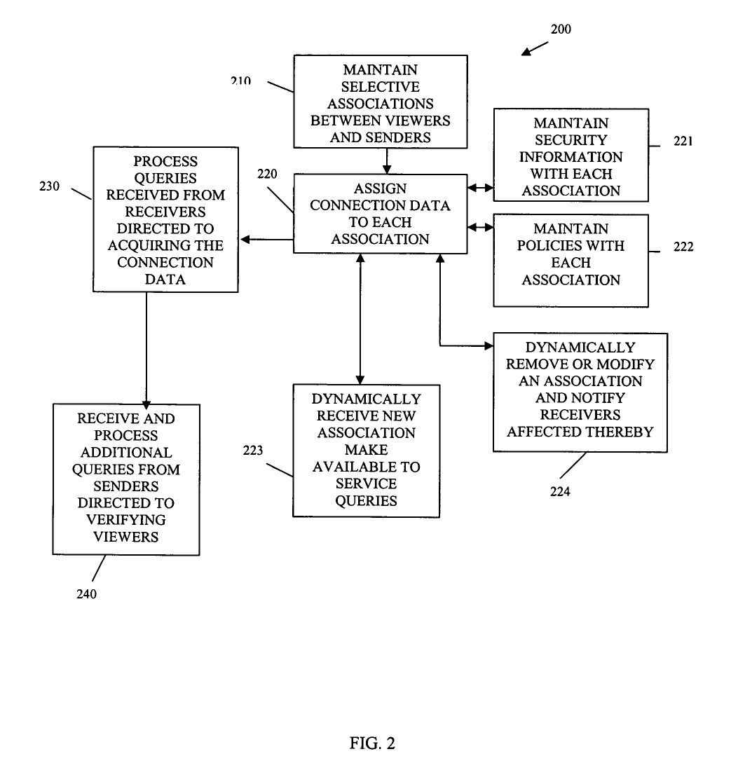

FIG. 2 is a diagram of one method 200 for facilitating the establishment of remote connections, according to an example embodiment. The method 200 (hereinafter “interface”) is implemented in a machine-readable and accessible medium and is accessible to other resources over a network. In one embodiment, the interface is associated with interactions between the receiver service of method 100 and the remote resource. That is, the interface is a mechanism by which information may be received from and placed into the remote resource of FIG. 1.

At 210, associations between viewers and senders are maintained. An association may be logically viewed as a record of a data store, such that the record is indexed based on one or more keys and includes a variety of related data associated with the key. Moreover, each association includes an identifier for a particular viewer and identifiers for one or more senders to which the particular viewer may establish remote connections with. An association may be indexed or keyed on the viewer identifier and/or the sender identifiers.

At 220, connection data is also assigned to each of the associations. The connection data can include a variety of information that permits a receiver service (such as method 100 of FIG. 1) to automatically and dynamically establish remote connections from a viewer to one or more senders. Thus, in one embodiment, the connection data may include an address or link to a particular sender. In other embodiments, the connection data may include protocol information and bandwidth limits associated with a particular connection to a particular sender.

In some embodiments, at 221, the interface may also maintain and distribute security information associated with each association. This may include housing with each association public keys, public certificates, and other security information for a viewer and/or for one or more of the senders. In this manner, the interface may be used as a central distribution point for security information that may be required by the sender(s) and/or viewer for any established remote connection.

In yet another embodiment, at 222, the interface may maintain policies associated with each association. A policy may define limitations on certain connections to certain senders. For example, a policy may state that sender A may only be remotely connected to on certain days or the week, certain calendar days, and/or at certain times of certain days. A policy may be directed to a sender or may be directed to a viewer. Policies may also be hierarchical. Thus, a viewer may have a global policy for all its associations and within each association each identified sender may have its own separate policies. Conflicts in policies may also be resolved by other global policies.

In some instances, at 223, the interface may dynamically receive a new association and may automatically and dynamically make that new association available for use. In this way, resources or entities (such as administrators) may access the interface and create new associations for a viewer, while a viewer is being serviced with remote connections by a receiver service. The interface may elect to push these new associations directly to receiver services or may make the new associations available for immediate use, the next time a receiver service queries the interface for a viewer's association. In a similar manner, the interface may permit dynamic deletion and/or modifications to existing associations. These deleted associations or modifications may also be dynamically communicated to affected receiver services.

At 230, the interface during some point in its processing receives and processes queries from receiver services. These queries include a sender's identification as a search operand. The sender's identification is searched to locate a particular association. The interface returns the association along with any security information and/or policies to the requesting receiver service. The association includes the sender identifications and the associated connection data. Armed with this, the receiver service may perform the processing of the method 100 to automatically establish remote connections to one or more sender(s).

In one embodiment, at 240, senders may also interact with the interface by issuing queries. A sender may want to contact and query the interface for purposes of determining if viewers are permitted to connect to them. Thus, a sender may seek policies or security information being maintained for a viewer or for the requesting sender. A sender may elect to contact the interface when a receiver service attempts to connect to the sender for a given viewer. Optionally, the receiver service may provide security information for the viewer, and the sender may seek to validate that security information via the interface.

In some embodiments, the interface includes mechanisms for administrators (administrator interfaces) to define, modify, delete, and create the associations and any security information or policies. Thus, the interface can serve as a dynamic interface to receiver services and senders and can also serve as a manual interface to administrators. The interface facilitates the establishment of remote connections between viewers and senders by assisting receiver services and senders in their negotiations and transactions with one another.

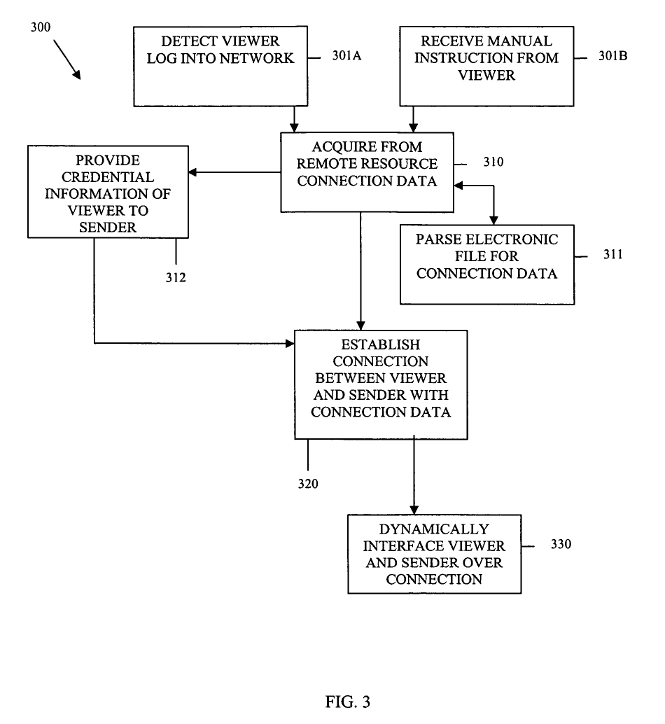

FIG. 3 is a diagram of another method 300 for establishing a remote connection, according to an example embodiment. The method 300 is implemented in a machine-accessible and readable medium. The medium may be removable medium that is interfaced to a processing device, memory, storage, or combinations of the same. In one embodiment, the medium is uploaded from removable media and installed on a processing device. In another embodiment, the medium is downloaded from a storage location over a network and installed on a processing device. In still other embodiments, a combination of media houses the instructions of the method 300 and are logically acquired and installed on a processing device. The method 300 is performed when the instructions associated with the method 300 are processed on a processing device.

At 301A, the instructions of the method 300 (hereinafter “instructions”) are automatically processed when a viewer is detected as having logged into a network. That is, part of a viewer's login script may include logic that automatically forks off or invokes the instructions. Alternatively, the instructions may run as a continually process (daemon) within an operating system (OS), and designed to detect when a viewer logs into the operating system or network and begins processing automatically on behalf of a successfully logged in viewer.

Alternatively, at 301B, the instructions may not be invoked or initiated until a viewer manually issues an instruction to invoke the instructions. Thus, a viewer may manually decide when and how to initiate the instructions.

Once the instructions are invoked, at 310, the instructions identifies the viewer (acquires the viewer's identification) and acquires connection data from a remote resource. Again, the remote resource may be a directory, a database, a data warehouse, a website service, an electronic file, and the like. Moreover, in some embodiments, the interface of method 200 may be used to interact with and acquire information from the remote resource. In some embodiments, at 311, the remote resource may have no particular interface, such that the interface of method 200 would prove useful. For example, the remote resource may be a file having tokenized or fielded data included within. The data may then be parsed by the instructions, at 311, to acquire the connection data for a viewer.

In one embodiment, at 311, the instructions may also provide credential information about the viewer to a sender. The sender uses the credential information to authenticate the viewer for a remote connection. In one embodiment, the sender may authenticate the credential information by also contacting an interface similar to the method 200 for purposes of comparing credential information that the interface has for a given viewer to what the instructions provided for the viewer.

At 320, the instructions in response to the acquired connection data establish a remote connection between the viewer and the sender. The connection data defines how to locate and connect to the sender. Once a connection is established, the instructions dynamically interface the viewer and the sender over the connection to one another, at 330. The presentation of the data to the viewer may be dictated by profiles or policies associated with the viewer. Thus, presentation may be customized for the viewer according to viewer preferences.

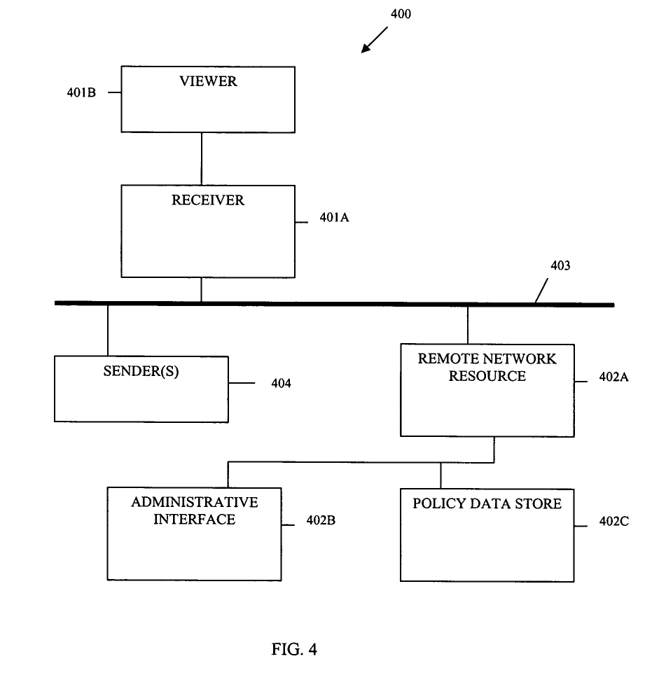

FIG. 4 is a diagram of one remote connection system 400, according to an example embodiment. The remote connection system 400 is implemented in a machine-accessible and readable medium and is adapted to process over a network. In one embodiment, the remote connection system 400 includes the processing of the methods 100, 200, and/or 300 of FIGS. 1-3.

The remote connection system 400 includes a receiver 401A and a remote network resource 402A. The receiver 401A communicates with the remote network resource 402A over a network 403. The network 403 may be hardwired, wireless, or a combination of hardwired and wireless. Moreover, in some embodiments, the remote network resource 402A may also communicate with the receiver 401A over the network 403.

The receiver 401A includes at least one viewer 401B that it services. In one embodiment, the receiver 401A is the receiver service of method 100 or the instructions of method 300. The receiver 401A acts as an intermediary for the viewer 401B to one or more senders 404 over the network 403. That is, the receiver 401A automatically identifies senders 404 by contacting the remote network resource 402A over the network 403. The receiver 401A is thus able to acquire the identities of the senders 404, connection data, security or credential information, and/or policies from the remote network resource 402A. This information permits the receiver 401A to automatically establish remote connections between the viewer 401B and the senders 404 over the network 403. In one embodiment, the receiver 401A queries, connects, and otherwise interacts with a remote network resource 402A that is the interface of method 200.

Optionally, the remote network resource 402A may include or being interfaced to an administrative interface 402B and a policy data store 402C. The administrative interface 402B provides a mechanism by which an administrator can define remote connections to senders 404 and viewers 401B, which are then dynamically distributed and managed by the remote network resource 402A and provided to receivers 401A and senders 404. The policy data store 402C may house policies that affect remote connections, senders 404, receivers 401A, and/or viewers 401B. The remote network resource 402A may be a directory, an electronic file, a database, a data warehouse, a website service, and the like.

The receiver 401A consumes the connection data associated with a viewer 401B for purposes of establishing a remote connection between the viewer 401B and the sender(s) 404 over the network 403. During that connection, the receiver 401A displays graphical data sent from services or displays of the senders 404 to displays of the viewer 401B. A single viewer 401B may be associated with a single display or a plurality of displays. Moreover, the receiver 401A may enforce display preferences associated with a particular viewer 401B.

Additionally, during any particular remote connection the receiver 401A may monitor actions or selections being made by a viewer 401B for that connection. These actions or selections are then forwarded over the network 403 by the receiver 401A to the appropriate sender 404 associated with the connection. In this manner, the receiver 401A acts as a conduit for each transaction occurring over each remote connection.

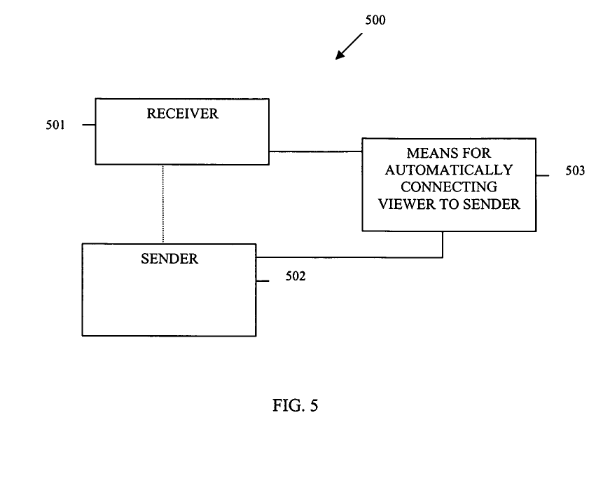

FIG. 5 is a diagram of another remote connection system 500, according to an example embodiment. The remote connection system 500 is implemented in a machine-accessible and readable medium and is accessible over a network. The network may be hardwired, wireless, or a combination of hardwired and wireless. In one embodiment, the remote connection system 500 implements the methods 100, 200, and/or 300 of FIGS. 1-3.

The remote connection system 500 includes a receiver 501, a sender 502, and a means for automatically connecting a viewer 503 to the sender 502. The receiver 501 may be implemented as the methods 100 and 300 of FIGS. 1 and 3. The receiver 501 is a service that automatically establishes a remote connection to the sender 502 over a network. To achieve this service, the receiver 501 enlists the assistance of the means for automatically connecting the viewer 503.

The means for automatically connecting the viewer 503 may be implemented as a service or a resource within hardware, software, and/or firmware. In some embodiments, the means for automatically connecting the viewer 503 is the interface of method 200 of FIG. 2. The means for connecting the viewer 503 may be an electronic file, a database, a data warehouse, a directory, a website service, and the like.

The means for connecting the viewer 503 may optionally include a search and retrieval interface which is made available to the receiver 501 and the sender 502 over the network. The means for connecting the viewer 503 maintains connection data for viewers. The connection data identifies senders 502 and any protocol information associated with the senders 502 for a given viewer. The means for connecting the viewer 503 thus serves as a centralized location on the network for managing connection data of viewers 503. Thus, viewers do not need to manually maintain and manage this information and security can be enforced.

In some embodiments, the means for connecting the viewer 503 also communicates security or credential information about viewers or senders to receivers 501 and/or senders 502. Thus, the means for connecting the viewer 503 can also centrally facilitate authentication and enforce policies by providing needed security information and policies to requesting receivers 501 and senders 502.

The receiver 501 manages a viewer's remote connections to senders 502 by acquiring connection data from a means for automatically connecting a viewer 503 over a network. The viewer does not need to be aware of these interactions and can rely on the services of the receiver 501. Moreover, security can be enforced if desired for each remote connection of the viewer to a particular sender 502.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. § 1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject mater lies in less than all features of a single disclosed embodiment. Thus the following claims are hereby incorporated into the Description of the Embodiments, with each claim standing on its own as a separate exemplary embodiment.

1. A method comprising:
contacting a remote resource having connection data for a viewer to interact with one or more senders;
acquiring the connection data from the remote resource;
establishing connections to the one or more senders on behalf of the viewer and in response to the connection data; and
receiving graphical data over the connections from the one or more senders.

2. The method of claim 1 further comprising, acquiring credential information for the viewer.

3. The method of claim 2 further comprising, transmitting the credential information to the one or more senders for purposes of permitting the one or more senders to authenticate the viewer for receiving the graphical data.

4. The method of claim 1 further comprising:
dynamically detecting a new sender for the viewer which is added in the remote resource;
dynamically establishing a new connection to the new sender using new connection data acquired from the remote resource;
dynamically receiving new graphical data over the new connection from the new sender; and
dynamically presenting the new graphical data to the viewer.

5. The method of claim 1 further comprising:
dynamically detecting a deletion of a selective one of the one or more senders from the remote resource; and
dynamically terminating a selective one of the connections associated with the selective one of the one or more senders preventing the viewer from viewing the graphical data associated therewith.

6. The method of claim 1 further comprising, presenting the graphical data to the viewer by selectively presenting the graphical data according to a viewer-defined profile or policy.

7. The method of claim 1 further comprising:
receiving a command issued from the viewer over a selective one of the connections; and
forwarding the command over the selective one of the connections to the associated sender.

8. A method comprising:
maintaining selective associations between viewers and senders over a network;
assigning connection data to each of the associations, wherein the connection data permits the viewers to remotely connect to the senders over the network; and
processing queries received over the network from receivers, wherein the queries are directed to acquiring identities of the senders and the connection data for given viewers, which are provided as search operands for the queries by the receivers.

9. The method of claim 8 further comprising, maintaining security information with each of the associations.

10. The method of claim 8 further comprising, maintaining policies with each of the associations.

11. The method of claim 8 further comprising, interacting with an administrative interface for receiving and defining the associations, the viewers, and the identities of the senders.

12. The method of claim 8 further comprising, receiving additional queries from one or more of the senders, wherein the additional queries are directed to verifying particular identities of selective ones of the viewers which are attempting to connect with the one or more senders.

13. The method of claim 8 further comprising, dynamically receiving a new association and dynamically making the association available to service the queries.

14. The method of claim 8 further comprising, dynamically removing or modifying selective ones of the associations and communicating the removals or modifications to selective ones of the receivers affected by the removals or modifications.

15. A system, comprising:
a receiver; and
a remote network resource, wherein the receiver manages connections between one or more viewers and one or more senders by interacting with the remote network resource to acquire connection data associated with the connections, and wherein the receiver receives graphical data over the connections from the one or more senders and presents the graphical data to the one or more viewers.

16. The system of claim 15 further comprising, an administrative interface in communication with the remote network resource for defining the connection data, identities of the one or more viewers, and identities for the one or more senders.

17. The system of claim 15 further comprising, a policy data store interfaced to the remote network resource for housing policies associated with the connections, the one or more senders, and the one or more viewers.

18. The system of claim 15, wherein the remote network resource is at least one of a directory, an electronic file, a database, and a data warehouse.

19. The system of claim 15, wherein at least one of the one or more viewers includes a plurality of display devices for viewing the graphical data.

20. The system of claim 15, wherein the receiver monitors actions of the one or more senders during the connections and forwards the actions over the connection to selective ones of the one or more senders.

21. A system, comprising:
a receiver;
a sender; and
means for automatically connecting a viewer interfaced to the receiver to the sender, wherein the means for automatically connecting the viewer provides the receiver with connection data for connecting the viewer to the sender.

22. The system of claim 21, wherein the means for automatically connecting the viewer is at least one of an electronic file, a database, a directory, and a data warehouse.

23. The system of claim 21, wherein the means for automatically connecting the viewer includes a search and retrieval interface accessible to at least one of the receiver and the sender.

24. The system of claim 21, wherein the means for automatically connecting the viewer also communicates with a policy store having policies regarding at least one of the receiver, the sender, the viewer, and the connection data.

25. A machine readable medium for establishing remote connections having instructions thereon, the instructions when executed performing the method comprising:
acquiring, from a remote resource over a network, connection data for a viewer to connect to a sender;
establishing a connection over the network between the sender and the viewer in response to the connection data; and
dynamically interfacing the viewer and the sender over the connection.

26. The medium of claim 25 further comprising, providing credential information associated with the viewer to the sender for purposes of permitting the sender to authenticate the viewer.

27. The medium of claim 25 further comprising, automatically processing the method after a viewer logs into the network.

28. The medium of claim 25 further comprising, processing the method in response to receiving a manual instruction from the viewer.

29. The medium of claim 26, wherein acquiring further includes parsing an electronic file for the connection data where the electronic file is the remote resource.

30. The medium of claim 25, wherein acquiring further includes issuing a query to the remote resource for purposes of acquiring the connection data.
